(19) United States
(12) Patent Application Publication
(10) Pub. No.: US 2011/0307575 A1
(43) Pub. Date: Dec. 15, 2011

(54) INFORMATION PROCESSING APPARATUS, DATA TRANSMISSION METHOD, NON-TRANSITORY COMPUTER-READABLE RECORDING MEDIUM ENCODED WITH DATA TRANSMISSION PROGRAM

(75) Inventors: Keisuke TERAMOTO, Itami-shi (JP); Atsushi OHSHIMA, Amagasaki-shi (JP); Masakazu MURAKAMI, Takarazuka-shi (JP); Masami YAMADA, Sennan-gun (JP); Akihiro TORIGOSHI, Amagasaki-shi (JP)

(73) Assignee: Konica Minolta Business Technologies, Inc., Chiyoda-ku (JP)

(21) Appl. No.: 13/152,506

(22) Filed: Jun. 3, 2011

(30) Foreign Application Priority Data
Jun. 11, 2010 (JP) 2010-134582

(51) Int. Cl. G06F 15/16

(52) U.S. Cl. 709/217

(57) ABSTRACT

An information processing apparatus includes: a content obtaining portion to obtain content written in a markup language; an extraction portion to extract destination information by analyzing the obtained content; a content display portion to display the obtained content; a generation portion to generate a set of destination information by successively adding a plurality of destination information extracted from a plurality of contents displayed by the content display portion; and a transmission portion to transmit data based on the generated set of destination information.

This application is based on Japanese Patent Application No. 2010-134582 filed with Japan Patent Office on Jun. 11, 2010, the entire content of which is hereby incorporated by reference.

### BACKGROUND OF THE INVENTION

1. Field of the Invention

The present invention relates to an information processing apparatus, a data transmission method, and a non-transitory computer-readable recording medium encoded with a data transmission program. More specifically, the present invention relates to an information processing apparatus transmitting data to a server via a network, a data transmission method executed in the information processing apparatus, and a non-transitory computer-readable recording medium encoded with a data transmission program.

2. Description of the Related Art

There is a known technique in which a personal computer (hereinafter referred to as “PC”) functioning as a client receives a Web page for file upload from a server and transmits data to a destination designated by the received Web page. For example, Japanese Patent Laid-Open No. 2007-189648 discloses an information processing apparatus including a communication means for two-way communication with servers on a network, a display means for allowing an Internet browser to display contents for allowing the communication means to transmit an image data file to any of the servers using a file upload function of the Internet browser, and a file creation means for creating the image data file to be transmitted to any of the servers from any given image captured in accordance with an operation on display contents of the display means. The display means displays a “send” button for transmitting a file, as the display contents. The file creation means is operated upon recognition of an operation of pressing the “send” button.

However, in the conventional information processing apparatus, an image data file to be transmitted to any of the servers is created from the displayed image, and therefore, with a single operation of pressing the send button, an image data file can be transmitted to only one server. Accordingly, when the user wishes to transmit the same data to a plurality of servers, the user has to repeat the operation of pressing the send button the number of times equal to the number of servers. The operation is thus cumbersome.

### SUMMARY OF THE INVENTION

The present invention is made to solve the aforementioned problem. In accordance with an aspect of the invention, an information processing apparatus includes: a content obtaining portion to obtain content written in a markup language; an extraction portion to extract destination information by analyzing the obtained content; a content display portion to display the obtained content; a generation portion to generate a set of destination information by successively adding a plurality of destination information extracted from a plurality of contents displayed by the content display portion; and a transmission portion to transmit data based on the generated set of destination information.

In accordance with another aspect of the present invention, a data transmission method executed in an information processing apparatus includes the steps of: obtaining content written in a markup language; extracting destination information by analyzing the obtained content; displaying the obtained content; generating a set of destination information by successively adding a plurality of destination information extracted from a plurality of contents displayed in the step of displaying content; and transmitting data based on the generated set of destination information.

In accordance with a further aspect of the present invention, a computer-readable non-transitory recording medium is encoded with a data transmission program causing a computer to execute processing including the steps of: obtaining content written in a markup language; extracting destination information by analyzing the obtained content; displaying the obtained content; generating a set of destination information by successively adding a plurality of destination information extracted from a plurality of contents displayed in the step of displaying content; and transmitting data based on the generated set of destination information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an overview of an information processing system in an embodiment of the invention.

FIG. 2 is an external perspective view of MFP.

FIG. 3 is a block diagram showing an exemplary hardware configuration of MFP.

FIG. 4 is a plan view showing an exemplary operation panel.

FIG. 5 is a block diagram showing an overall function of CPU of MFP together with information stored in EEPROM.

FIG. 6 shows an example of a display screen including an operation screen.

FIG. 7 shows an example of a data designation screen.

FIG. 8 is a flowchart showing an exemplary flow of a browsing process.

FIG. 9 is a flowchart showing an exemplary flow of a data transmission process.

FIG. 10 is a flowchart showing an exemplary flow of a data designation process.

FIG. 11 is a block diagram showing an overall function of CPU of MFP 100 together with information stored in EEPROM in accordance with a second embodiment.

FIG. 12 shows an example of a display screen including an operation screen in the second embodiment.

FIG. 13 shows an example of a select screen.

FIG. 14 is a flowchart showing an exemplary flow of a data transmission process in the second embodiment.

### DESCRIPTION OF THE PREFERRED EMBODIMENTS

The preferred embodiments of the present invention will be described below in conjunction with the drawings. In the following description, the same or corresponding parts are denoted by the same reference characters. Their names and functions are also the same. Thus, a detailed description thereof will not be repeated.

### First Embodiment

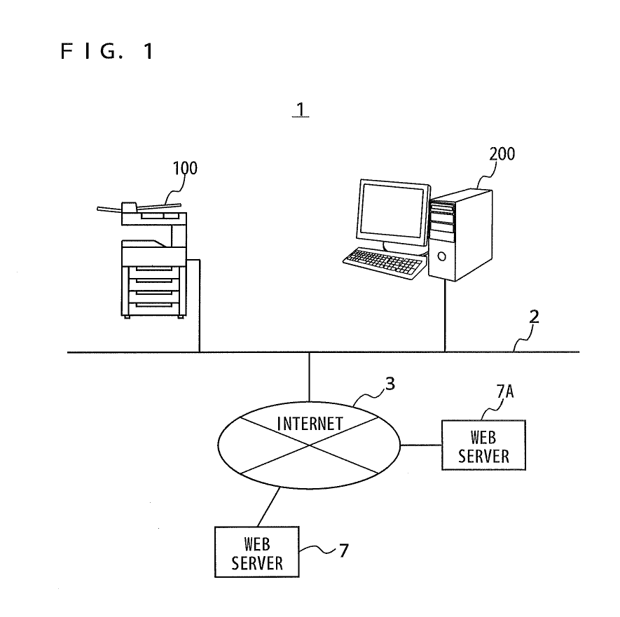

FIG. 1 is a diagram showing an overview of an information processing system in an embodiment of the present invention. Referring to FIG. 1, an information processing system 1 includes a Multi Function Peripheral (hereinafter referred to as “MFP”) 100 and a PC 200, each connected to a network 2, and Web servers 7, 7A connected to the Internet 3. MFP 100 is an example of an information processing apparatus, and includes multiple functions such as a scanner function, a printer function, a copy function, and a facsimile function.

Network 2 is a local area network (LAN) and is connected to the Internet 3 through a gateway. Therefore, MFP 100 can communicate with Web servers 7, 7A connected to the Internet 3. MFP 100 and Web servers 7, 7A communicate using a communication protocol such as HTTP (Hyper Text Transfer Protocol), though not limited thereto. Network 2 is not limited to LAN and may be the Internet, a wide area network (WAN), a public switched telephone network (PSTN), or the like.

MFP 100 may execute a browsing program and has a browser function. For example, when the user designates a URL (Uniform Resource Locator) of a Web page stored in Web server 7, MFP 100 requests Web server 7 to transmit the Web page specified by the URL and receives and displays the Web page transmitted by Web server 7. Here, a Web page is text data written in a markup language such as HTML (Hyper Text Markup Language) or XML (Extensible Markup Language). In the following, the process of MFP 100 downloading and displaying a Web page is referred to as a browsing process.

Web servers 7, 7A each transmit a Web page to MFP 100 in response to a request from MFP 100 functioning as a Web browser. The Web page transmitted by Web servers 7, 7A includes destination information for transmitting data and includes a command to transmit data based on the destination information. The destination information may include a URL for specifying one of Web servers 7, 7A that has transmitted the Web page or may include a URL for specifying another file server. Web servers 7, 7A each have a CGI (Common Gateway Interface) and activates an application program in response to a request from MFP 100 functioning as a Web browser. Here, Web servers 7, 7A each function as a file server and activate an application program to receive data transmitted by MFP 100 and store the received data, in response to a request from MFP 100, by way of example.

In the present embodiment, MFP 100 is described as an example of the information processing apparatus. However, MFP 100 may be replaced by any device that includes a browser function, for example, such as a personal computer, a scanner, a printer, or a facsimile.

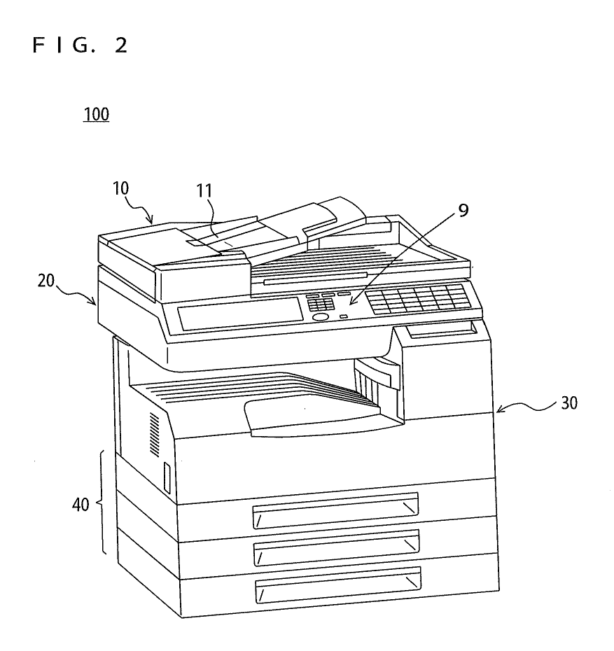

FIG. 2 is an external perspective view of MFP. Referring to FIG. 2, MFP 100 includes an operation panel 9, an Automatic Document Feeder (ADF) 10, a document scanning portion 20, an image forming portion 30, and a paper-feeding portion 40.

ADF 10 automatically transfers multiple sheets of a document set on a document feeding tray 11, one by one, to a prescribed document scanning position set on a platen glass of document scanning portion 20, and discharges the document, from which a document image is scanned by document scanning portion 20, onto a document output tray. Document scanning portion 20 includes a light source for applying light to a document transferred to the document scanning position and a photoelectric transducer receiving light reflected by the document, and scans a document image in accordance with the size of the document. The photoelectric transducer converts the received light into an electrical signal as image data for storage into a memory or output to image forming portion 30.

Image forming portion 30 forms an image by well-known electrophotography. Image forming portion 30 performs a variety of data processing such as shading on the image data input from document scanning portion 20 and forms an image on paper transferred from paper-feeding portion 40 based on the processed image data. Paper-feeding portion 40 transfers the paper accommodated in the paper tray to image forming portion 30.

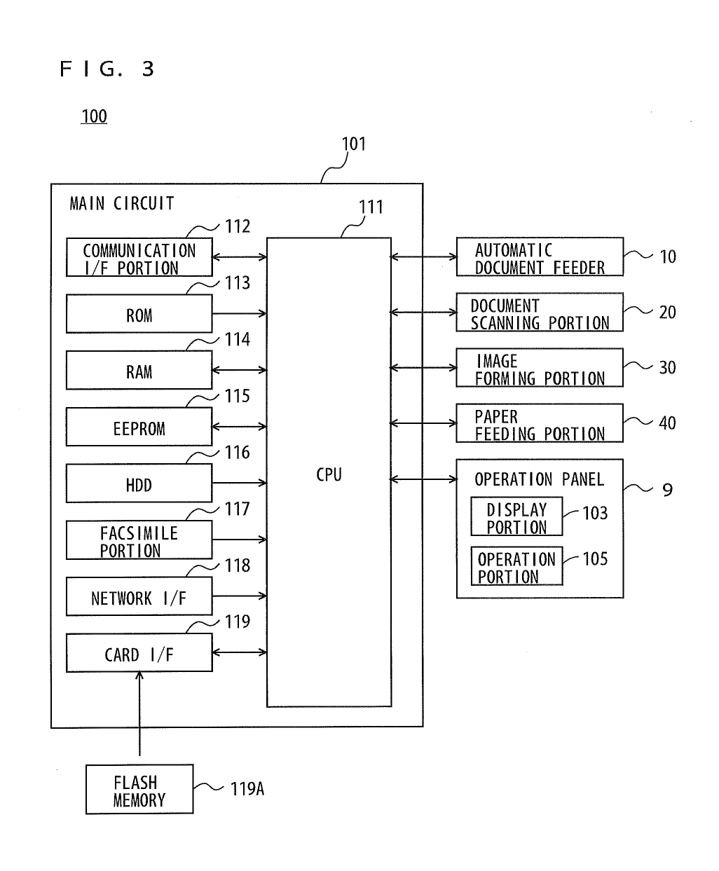

FIG. 3 is a block diagram showing an exemplary hardware configuration of MFP. Referring to FIG. 3, MFP 100 includes a main circuit 101, ADF 10, document scanning portion 20, image forming portion 30, paper-feeding portion 40, and operation panel 9 serving as a user interface.

Main circuit 101 includes a CPU 111, a communication interface (I/F) portion 112, a ROM (Read Only Memory) 113, a RAM (Random Access Memory) 114, an EEPROM (Electronically Erasable and Programmable ROM) 115, a hard disk drive (HDD) 116 as a mass storage device, a facsimile portion 117, a network I/F 118, and a card interface (I/F) 119 to which a flash memory 119A is attached. CPU 111 is connected with ADF 10, document scanning portion 20, image forming portion 30, paper feeding portion 40, and operation panel 9 to control the entire MFP 100.

ROM 113 stores a program executed by CPU 111 and data required to execute the program. RAM 114 is used as a work area for CPU 111 to execute a program.

Communication I/F portion 112 is an interface for connecting MFP 100 to another device via a serial communication cable. The connection may be either wired or wireless.

Facsimile portion 117 is connected with a public switched telephone network (PSTN) to send facsimile data to PSTN or receive facsimile data from PSTN. Facsimile portion 117 stores the received facsimile data into HDD 116 or outputs the same to image forming portion 30. Image forming portion 30 prints the facsimile data received by facsimile portion 117 on paper. Facsimile portion 117 also converts the data stored in HDD 116 into facsimile data and sends the facsimile data to a facsimile machine connected to PSTN.

Network I/F 118 is an interface for connecting MFP 100 to network 2. CPU 111 can communicate with Web servers 7, 7A connected to the Internet 3 through network I/F 118.

Flash memory 119A is attached to card I/F 119. CPU 111 can access flash memory 119A through card I/F 119 and can load a program stored in flash memory 119A into RAM 114 for execution. The program executed by CPU 111 may not be the program stored in flash memory 119A but may be a program stored in any other storage medium, a program stored in HDD 116, or a program written in HDD 116 by any other computer connected to network 2 through network I/F 118.

It is noted that a recording medium for storing a program is not limited to flash memory 119A and may be an optical disk (MO (Magnetic Optical Disc)/MD (Mini Disc)/DVD (Digital Versatile Disc)), an IC card, an optical card, or a semiconductor memory such as a mask ROM, EPROM (Erasable Programmable ROM), or EEPROM (Electrically Erasable and Programmable ROM).

The program referred to herein includes not only a program directly executable by CPU 111 but also a source program, a compressed program, an encrypted program, and the like.

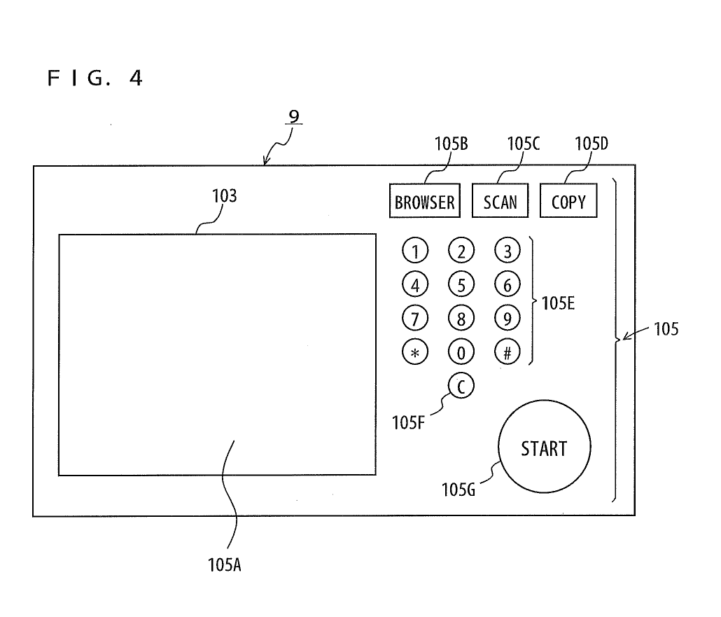

Operation panel 9 is provided on a top surface of MFP 100 and includes a display portion 103 and an operation portion 105. FIG. 4 is a plan view showing an exemplary operation panel. Referring to FIG. 4, operation panel 9 includes display portion 103 and operation portion 105. Display portion 103 is a display such as a liquid crystal display or an organic ELD (Electroluminescence Display) to display an instruction menu for users, information about the obtained display data, and the like.

Operation portion 105 accepts an operation by the user and outputs the accepted operation to CPU 111. Operation portion 105 includes a touch panel 105A superimposed on display portion 103, a browser key 105B to which an operation of designating execution of a browsing process is allocated, a scan key 105C to which an operation of designating execution of a scan process is allocated, a copy key 105D to which an operation of designating execution of a copy process is allocated, a ten-key pad 105E, a clear key 105F for cancelling the input, and a start key 105G. Touch panel 105A is formed of a transparent material and is arranged superimposed on display portion 103. When the user touches touch panel 105A by the finger, touch panel 105A detects the touched part as a pointing position for output to CPU 111.

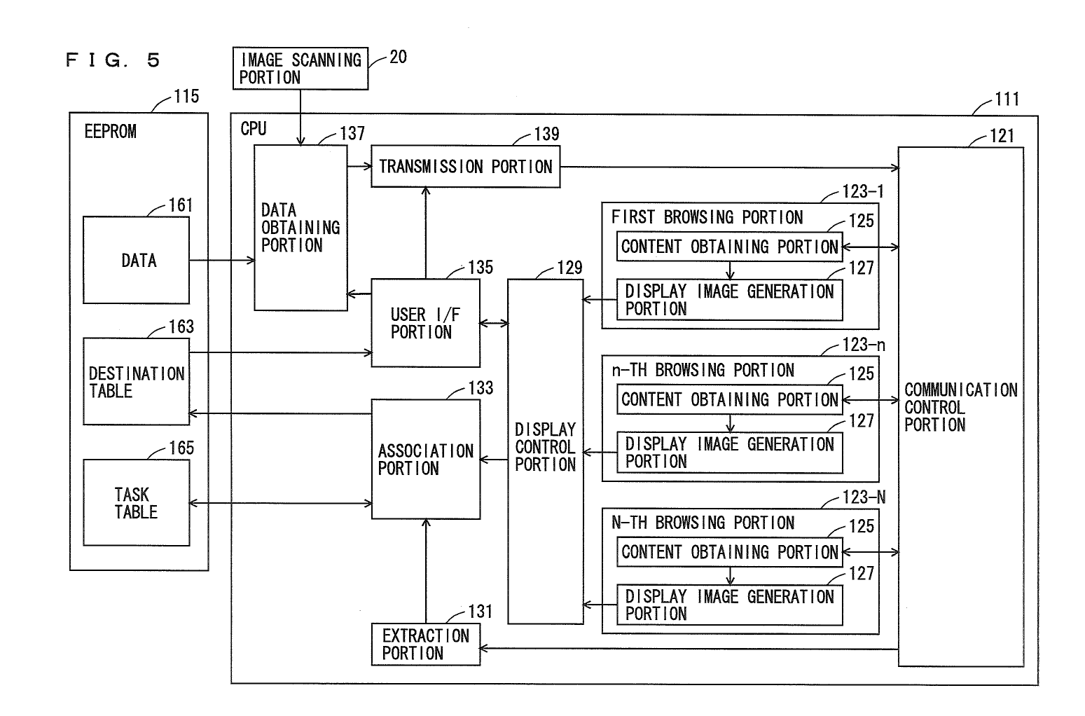

FIG. 5 is a block diagram showing an overall function of CPU of MFP together with information stored in EEPROM. The functions of CPU 111 shown in FIG. 5 are implemented by CPU 111 executing a data transmission program stored in ROM 113, EEPROM 115, HDD 116, or flash memory 119A.

Referring to FIG. 5, CPU 111 includes a communication control portion 121 controlling network I/F 118, first to N-th browsing portions 123-1 to 123-N (N is an integer equal to or greater than 2), a display control portion 129 controlling display portion 103, an extraction portion 131 extracting destination information, an association portion 133, a user I/F portion 135, a data obtaining portion 137 obtaining data, and a transmission portion 139 transmitting data.

EEPROM 115 stores data 161, a destination table 163, and a task table 165. Data 161 includes image data output by document scanning portion 20 scanning a document, facsimile data received by facsimile portion 117, data stored in flash memory 119A, and data transmitted by PC 200 to MFP 100. Destination table 163 and task table 165 will be described later.

First to N-th browsing portions 123-1 to 123-N each are a task formed in CPU 111 by CPU 111 executing a browsing program. CPU 111 can execute a plurality of browsing programs, and the same number of tasks as the number of browsing programs executed by CPU 111 are formed in CPU 111.

CPU 111 executes a browsing program in response to the user designating browser key 105B included in operation portion 105. Therefore, the same number of tasks as the number of times the user designates browser key 105B are formed in CPU 111. In the example shown in FIG. 5, browser key 105B is designated N times so that first to N-th browsing portions 123-1 to 123-N are generated. Here, any one of first to N-th browsing portions 123-1 to 123-N is denoted by the n-th browsing portion 123-n (n is a positive integer).

CPU 111 allocates task identification information for identifying a task to the n-th browsing portion 123-n. When the user inputs the operation of designating the n-th browsing portion 123-n and an instruction to end by operating operation portion 105, the n-th browsing portion 123-n ends the execution of the browsing program.

The n-th browsing portion 123-n executes a browsing process. Specifically, it includes a content obtaining portion 125 and a display image generation portion 127. When the user inputs a URL to operation portion 105, content obtaining portion 125 accepts the input URL and obtains the content specified by the accepted URL. For example, content obtaining portion 125 displays alphanumerical software keys on display portion 103 and accepts a URL when touch panel 105A of operation portion 105 detects the user's designation of the software keys. The URL is information for specifying content, here, a Web page, and is a network address indicating the location of the content. Content obtaining portion 125 outputs a GET command including the accepted URL to communication control portion 121. Here, the URL included in the GET command specifies Web server 7, by way of example.

Here, content is a Web page written in a markup language such as HTML, and prepared and stored beforehand in order to upload data to Web servers 7, 7A. The Web page as content at least includes destination information and content identification information. The destination information is information for identifying a storage location to which data is uploaded, and includes a URL allocated to the server to which data is uploaded, or a CGI (Common Gateway Interface) command. The destination information is indicated by a FORM tag written in the Web page. The content identification information is the name given to the Web page and is indicated by a TITLE tag written in the Web page.

Communication control portion 121 controls network I/F 118 to transmit and receive data. Specifically, in response to input of a GET command including a URL from the n-th browsing portion 123-n, communication control portion 121 sends the input GET command to network 2 through network I/F 118 and waits for reception of a Web page. Here, communication control portion 121 detects and temporarily stores the task identification information for identifying the n-th browsing portion 123-n that outputs the GET command. The GET command sent out to network 2 by network I/F 118 is received by Web server 7, if the URL included in the GET command specifies Web server 7.

Web server 7 receiving the GET command sends back the Web page specified by the URL to MFP 100 that has transmitted the GET command. Network I/F 118 thus receives the Web page. When network I/F 118 receives the Web page, communication control portion 121 obtains the received Web page. Communication control portion 121 outputs the Web page received in response to transmission of the GET command, to the n-th browsing portion 123-n specified by the temporarily stored task identification information. The correspondence between the transmitted GET command and the received Web page can be established, for example, using the number of a session established with Web server 7 or the number of a communication port.

When a Web page is input from communication control portion 121, content obtaining portion 125 of the n-th browsing portion 123-n outputs the input Web page to display image generation portion 127. When a Web page is input from content obtaining portion 125, display image generation portion 127 generates a display image based on the input Web page and outputs the generated display image to display control portion 129.

Display control portion 129 controls display portion 103 to allow display portion 103 to display a display image. Specifically, when a display image is input from the n-th browsing portion 123-n, display control portion 129 generates a window including the input display image and allows display portion 103 to display the generated window. Display control portion 129 generates one window corresponding to the n-th browsing portion 123-n and allocates window identification information for identifying the generated window to the n-th browsing portion 123-n. Therefore, display control portion 129 displays the display image input from the n-th browsing portion 123-n in the window identified by the window identification information allocated to the n-th browsing portion 123-n. When display control portion 129 sets the window in a viewable state, display control portion 129 displays the window including the display image or the minimized window on display portion 103. When display control portion 129 displays the minimized window on display portion 103, the display image is not displayed on display portion 103 but the window identification information for identifying the window is displayed on display portion 103.

When the n-th browsing portion 123-n ends the execution of the browsing program, display control portion 129 closes the window identified by the window identification information allocated to the n-th browsing portion 123-n. Specifically, in the screen appearing on display portion 103, the window identified by the window identification information allocated to the n-th browsing portion 123-n is not displayed.

Extraction portion 131 extracts a set of the task information and the Web page from data transmitted/received by communication control portion 121 through network I/F 118. Extraction portion 131 may request communication control portion 121 to obtain a set of the task information and the Web page. Alternatively, extraction portion 131 may monitor the Web page output by communication control portion 121 to the n-th browsing portion 123-n.

Extraction portion 131 analyzes the extracted Web page to extract the destination information and the content identification information. Specifically, extraction portion 131 searches the extracted Web page for TITLE tags and extracts the portion enclosed by the extracted two TITLE tags as content identification information. Extraction portion 131 then searches the extracted content for FORM tags and extracts destination information from the portion enclosed by the extracted two FORM tags in which “submit” is written. For example, in a case where a Web page has a description of two FORM tags “<form” and “form>,” and the description from “<form” to “form>” includes a description “action=“http://xxxx.cgi” method=“post” . . . type=“submit” name=“transmission”,” the destination information is a set of “http://xxxx.cgi” and a POST command “post.” Here, . . . indicates the omitted description. Extraction portion 131 outputs, to association portion 133, the extracted destination information and content identification information, and the task information that makes a set with the Web page from which they are extracted.

Association portion 133 manages task table 165 and destination table 163 stored in EEPROM 115. Task table 165 includes a task record that defines the association between a window displayed by display control portion 129 and a task to which the window is allocated. Therefore, the task table includes the same number of task records as the number of windows displayed by display control portion 129. The task record includes an item of task identification information and an item of window identification information. Destination table 163 includes a destination record that defines the association between the destination information extracted by extraction portion 131 and the window including an image of the Web page including that destination information. The destination record includes an item of task identification information, an item of destination information, and an item of content identification information.

Every time it is detected that a window is generated by display control portion 129, association portion 133 obtains from display control portion 129 a set of the task identification information and the window identification information of the generated window. Then, association portion 133 generates a task record in which the obtained task identification information is set in the item of task identification information and the obtained window identification information is set in the item of window identification information. Association portion 133 then adds the generated task record to task table 165 stored in EEPROM 115.

Association portion 133 receives a set of the destination information, the content identification information, and the task identification information from extraction portion 131 and associates the window identification information and the destination information, which are associated with the same task identification information, with each other using task table 165 stored in EEPROM 115. Specifically, if the task records included in task table 165 include a task record in which the task identification information input from extraction portion 131 is set in the item of task identification information, then association portion 133 generates a destination record in which the task identification information input from extraction portion 131 is set in the item of task identification information, the destination information input from extraction portion 131 is set in the item of destination information, and the content identification information input from extraction portion 131 is set in the item of content identification information. Then, association portion 133 adds the generated destination record to destination table 163 stored in EEPROM 115.

Furthermore, every time a window is closed by display control portion 129, association portion 133 obtains the window identification information of the closed window from display control portion 129 and deletes the task record in which the obtained window identification information is set in the item of window identification information, from task table 165 stored in EEPROM 115. When a task record is deleted from task table 165, association portion 133 deletes from destination table 163 a destination record in which the same task identification information as the task identification information set in the item of task identification information of the deleted task record is set in the item of task identification information. Therefore, association portion 133 associates the window identification information and the destination information with each other using task table 165 and destination table 163. Thus, destination table 163 includes the same number of destination records as the number of windows displayed by display control portion 129.

User I/F portion 135 accepts an instruction input to operation portion 105 by the user. When the user operates operation portion 105 to input an instruction to display an operation screen, user I/F portion 135 generates and displays an operation screen. Specifically, user I/F portion 135 reads out a destination record from destination table 163 stored in EEPROM 115, generates an operation screen in which content identification information included in the read destination record is listed, and outputs the generated operation screen to display control portion 129. If a plurality of destination records are included in destination table 163, user I/F portion 135 generates a screen including a plurality of content identification information included in a plurality of destination records. Therefore, if a plurality of Web pages are displayed by display control portion 129, the operation screen includes the respective content identification information of the plurality of Web pages. When the operation screen is input from user I/F portion 135, display control portion 129 displays the input operation screen on display portion 103.

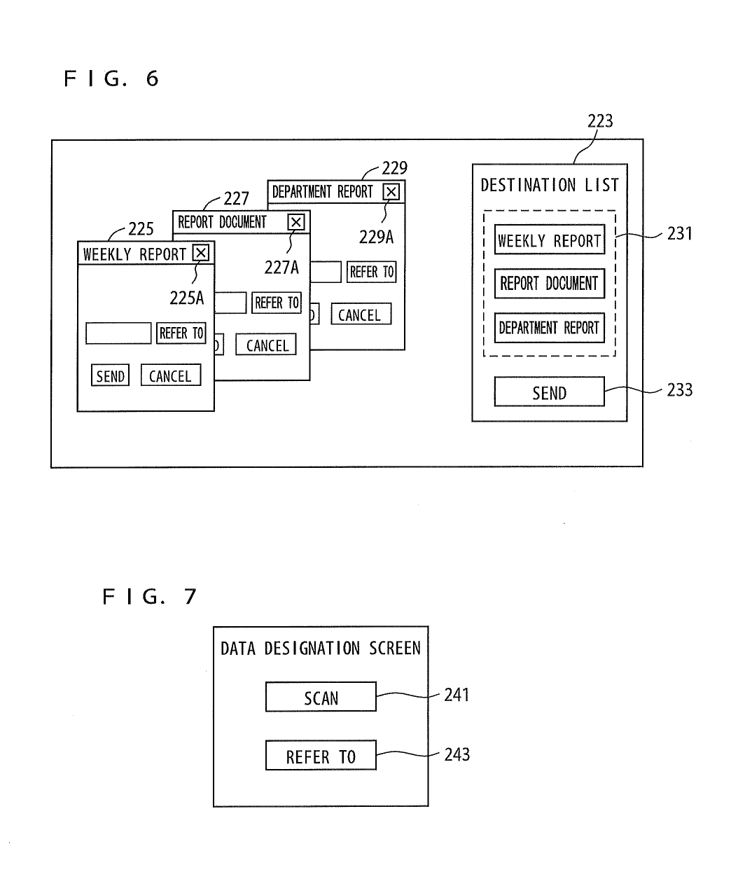

FIG. 6 shows an example of a display screen including the operation screen. Referring to FIG. 6, the display screen includes three windows including Web pages 225, 227, 229, and a window including an operation screen 223. The content identification information of Web page 225 is “weekly report,” the content identification information of Web page 227 is “report document,” and the content identification information of Web page 229 is “department report.” Operation screen 223 includes a destination list display region 231 and a Send button 233 arranged below destination list display region 231. It is noted that the dotted line in the figure is given only for the sake of illustration and actually does not exist. Destination list display region 231 includes the content identification information “weekly report” of Web page 225, the content identification information “report document” of Web page 227, and the content identification information “department report” of Web page 229. Send button 233 is labeled with a character string “SEND,” and an operation of designating transmission by the user is allocated to Send button 233.

Returning to FIG. 5, when the user designates Send button 233 included in operation screen 223, user I/F portion 135 reads destination table 163 and outputs a plurality of destination information set in a plurality of destination records included in the read destination table 163 to transmission portion 139. The destination information extracted from a plurality of Web pages displayed on display portion 103 at the moment when the user designates Send button 233 is output to transmission portion 139. Therefore, the destination information extracted from Web pages not displayed as a plurality of windows on display portion 103 is not output to transmission portion 139. Furthermore, when Send button 233 displayed on the operation screen is designated, user I/F portion 135 outputs a data designation screen to display control portion 129. When the data designation screen is input from user I/F portion 135, display control portion 129 displays the data designation screen on display portion 103.

FIG. 7 shows an example of the data designation screen. Referring to FIG. 7, the data designation screen includes a Scan button 241 labeled with a character “SCAN” and a Refer-to button 243 labeled with a character “REFER TO.” Scan button 241 is a button for designating image data output by document scanning portion 20 scanning a document, and Refer-to button 243 is a button for designating data stored in HDD 116.

Returning to FIG. 5, when the user operates operation portion 105 to designate Scan button 241 displayed on the data designation screen, user I/F portion 135 outputs a scan instruction to data obtaining portion 137. When the user operates operation portion 105 to designate Refer-to button 243 displayed on the data designation screen, user I/F portion 135 outputs a refer-to instruction to data obtaining portion 137.

Data obtaining portion 137 obtains data designated by the user. When a scan instruction is input from user I/F portion 135, data obtaining portion 137 allows document scanning portion 20 to scan a document and outputs image data output by document scanning portion 20, as transmission data to transmission portion 139. When a refer-to instruction is input from user I/F portion 135, data obtaining portion 137 outputs to display control portion 129 a list screen in which files names for identifying data stored in HDD 116 are listed. Display control portion 129 displays the list screen on display portion 103. Data obtaining portion 137 outputs the data specified by the file name selected by the user from a plurality of file names listed in the list screen, as transmission data to transmission portion 139.

Transmission portion 139 receives a plurality of destination information from user I/F portion 135 and receives the transmission data from data obtaining portion 137. Transmission portion 139 transmits the transmission data input from data obtaining portion 137 based on each of a plurality of destination information input from user I/F portion 135. Therefore, the transmission data is transmitted to a plurality of destinations determined by a plurality of destination information. Accordingly, the transmission data is transmitted based on the destination information extracted from a plurality of Web pages displayed on display portion 103 at the moment when the user designates Send button 233.

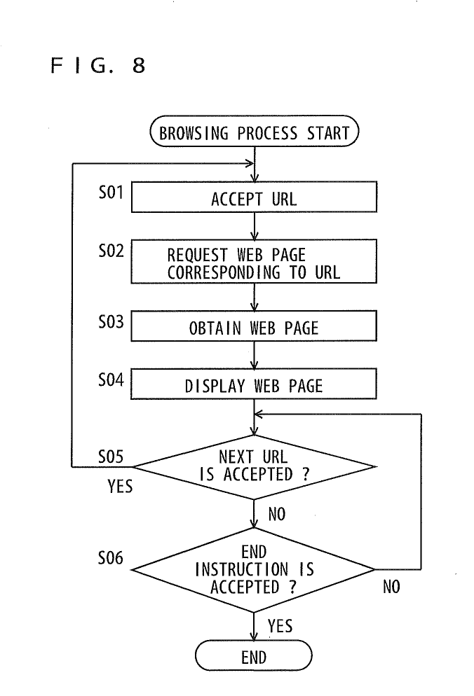

FIG. 8 is a flowchart showing an exemplary flow of the browsing process. The browsing process is a process executed by CPU 111 executing a browsing program stored in EEPROM 115. Referring to FIG. 8, CPU 111 accepts a URL (step S01). A URL input by the user operating touch panel 105A is accepted, and the process proceeds to step S02. A URL may be accepted in such a manner that the user designates a URL registered beforehand, for example, in “FAVORITES.”

In step S02, a Web page corresponding to the URL accepted in step S01 is requested, and the process proceeds to step S03. Specifically, a GET command including the URL accepted in step S01 is transmitted to network 2 through network I/F 118. Here, the URL included in the GET command specifies Web server 7, by way of example. If the URL included in the GET command specifies Web server 7, the GET command is received by Web server 7. Web server 7 receiving the GET command sends back the Web page specified by the URL to MFP 100 that has transmitted the GET command. Network I/F 118 thus receives the Web page.

In step S03, the Web page received by network I/F 118 is obtained, and the process proceeds to step S04. In step S04, an image of the Web page obtained in step S03 is displayed on display portion 103.

In the next step S05, it is determined whether the next URL is accepted. If the next URL is accepted (YES in step S05), the process returns to step S01. If not (NO in step S05), the process proceeds to step S06. In step S06, it is determined whether an end instruction is accepted. It is determined whether an instruction to end the browsing process is accepted by the user operating touch panel 105A. The instruction to end the browsing process includes an operation of closing a window. If an end instruction is accepted (YES in step S06), the browsing process ends. If not (NO in step S06), the process returns to step S05.

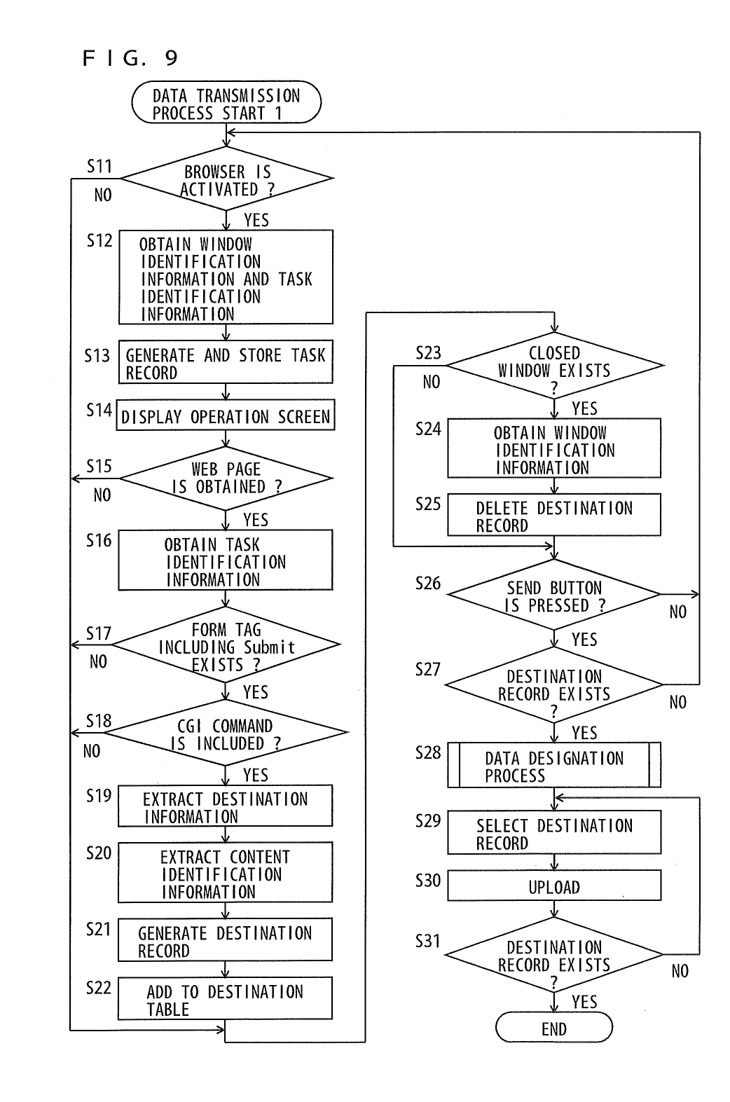

FIG. 9 is a flowchart showing an exemplary flow of a data transmission process. The data transmission process is a process executed by CPU 111 executing a data transmission program stored in ROM 113, EEPROM 115, HDD 116, or flash memory 119A. Referring to FIG. 9, CPU 111 determines whether the browser is activated (step S11). If there exists at least one task that executes a browsing program, it is determined that the browser is activated. If the browser is activated (YES in step S11), the process proceeds to step S12. If not (NO in step S11), the process proceeds to step S23.

In step S12, the window identification information of the window allocated to the task executing the browsing program, and the task identification information allocated to the task, are obtained. The process then proceeds to step S13. If there are plurality of tasks executing browsing programs, the task identification information and the window identification information allocated to each of a plurality of tasks executing browsing programs are obtained.

In step S13, a task record is generated which includes the window identification information and the task identification information obtained in step S12, and the generated task record is additionally stored in task table 165 stored in EEPROM 115. In the next step S14, the operation screen shown in FIG. 6 is displayed, and the process proceeds to step S15.

In step S15, it is determined whether a Web page is obtained. If a Web page is obtained, the process proceeds to step S16. If not, the process proceeds to step S23. In step S16, the task identification information of the task that requests transmission of the Web page obtained in step S15 is obtained. If a Web page is received by network I/F 118, it is determined that a Web page is obtained, and the task identification information of the task that displays the obtained Web page is obtained.

In the next step S17, it is determined whether a description of the FORM tag including “submit” exists in the Web page obtained in step S15. If the FORM tag including “submit” is written, the process proceeds to step S18. If not, the process proceeds to step S23.

In step S18, it is determined whether the portion enclosed by the FORM tags extracted in step S17 includes a CGI command. If it includes a CGI command, the process proceeds to step S19. If not, the process proceeds to step S23. Here, the portion enclosed by the FORM tags includes a CGI command, by way of example. However, the portion enclosed by the FORM tags may include a URL only showing a storage location as long as it includes destination information.

In step S19, destination information is extracted from the portion enclosed by the FORM tags extracted in step S17, and the process proceeds to step S19. For example, if the portion enclosed by the FORM tags includes a description “action=“http://xxxx.cgi” method=“post” . . . type=“submit” name=“transmission”,” a set of “http://xxxx.cgi” showing a CGI command and “post” showing a POST command is extracted as destination information from the description.

In step S20, content identification information is extracted from the Web page obtained in step S15, and the process then proceeds to step S21. Specifically, the portion enclosed by the TITLE tags is extracted as content identification information from the description of the Web page.

In step S21, a destination record is generated, and the process then proceeds to step S22. A destination record is generated which includes the task identification information obtained in step S16, the destination information extracted in step S19, and the content identification information extracted in step S20. In the next step S22, the destination record generated in step S21 is added to destination table 163 stored in EEPROM 115, and the process then proceeds to step S23.

The process from step S11 to step S22 is executed once every time CPU 111 executes the browsing program. When the executed browsing program displays a Web page including destination information, the Web page is obtained in step S15, and one destination record is generated for the obtained Web page in step S16 to step S22.

In step S23, it is determined whether there exists a closed window. If a closed window exists, the process proceeds to step S24. If not, the process proceeds to step S26.

In step S24, the window identification information of the closed window is obtained, and the process proceeds to step S25. Specifically, if a task executing a browsing program is ended, CPU 111 obtains the window identification information of the window allocated to the ended task.

In step S25, the destination record including the window identification information obtained in step S24 is deleted from destination table 163 stored in EEPROM 115, and the process then proceeds to step S26. Specifically, a task record including the window identification information obtained in step S24 is extracted from task records included in the task table stored in EEPROM 115, and the task identification information included in the extracted task record is obtained. Then, the destination record including the obtained task identification information is deleted from the destination records included in the destination table stored in EEPROM 115.

In step S26, it is determined whether Send button 233 included in the operation screen displayed in step S14 is designated. If Send button 233 is designated, the process proceeds to step S27. If not, the process returns to step S11.

In step S27, it is determined whether a destination record exists in destination table 163 stored in EEPROM 115. If a destination record exists, the process proceeds to step S28. If not, the process returns to step S11. This is because if no destination record exists, a Web page including destination information is not displayed.

In step S28, the data designation process is executed, and the process then proceeds to step S29. The data designation process, which will be detailed later, is a process of obtaining transmission data to be transmitted.

In the next step S29, one destination record is selected as a process target from among the destination records included in destination table 163 stored in EEPROM 115, and the process then proceeds to step S30. In step S30, the transmission data is uploaded by transmitting the transmission data obtained in step S28 based on the destination information set in the destination record selected in step S29. The process then proceeds to step S31.

In step S31, it is determined whether there exists a destination record that has not yet been set as a process target. If there exists a destination record that has not yet been set as a process target, the process returns to step S29. If not, the data transmission process ends. Therefore, data is transmitted based on all the destination information set in the destination records included in destination table 163 stored in EEPROM 115 at the moment when Send button 233 in the operation screen is designated. In other words, data is transmitted based on the destination information included in each of a plurality of Web pages displayed on display portion 103 at the moment when Send button 233 in the operation screen is designated. Conversely, data is not transmitted to a destination defined by the destination information included in a Web page not displayed on display portion 103 at the moment when Send button 233 in the operation screen is designated. Therefore, the user can select a destination of transmission data by allowing display portion 103 to display a Web page before designating Send button 233. Furthermore, the user can confirm the destination by looking at the Web page displayed on display portion 103.

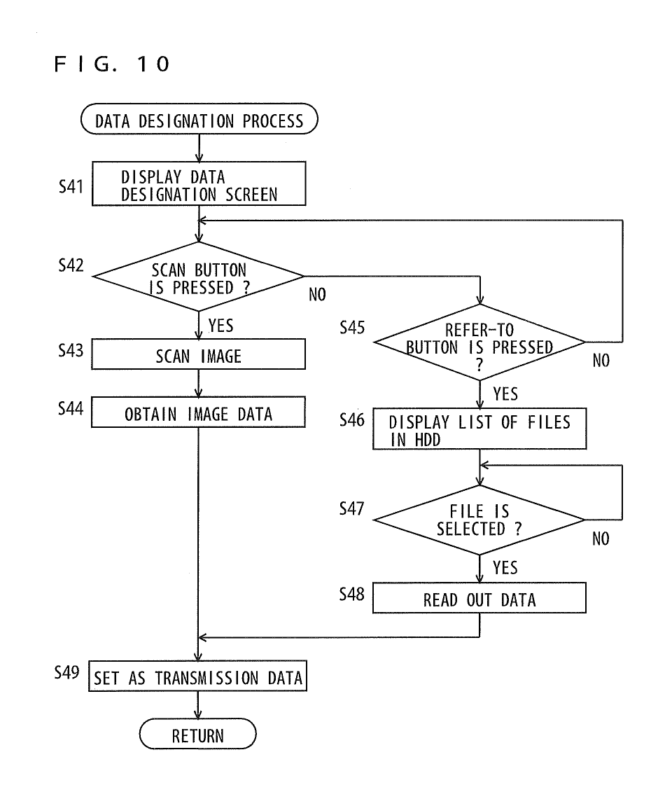

FIG. 10 is a flowchart showing an exemplary flow of the data designation process. The data designation process is a process executed in step S28 in FIG. 9. Referring to FIG. 10, CPU 111 displays the data designation screen shown in FIG. 7 on display portion 103 (step S41). The process then proceeds to step S42.

In step S42, it is determined whether Scan button 241 included in the data designation screen is designated. If Scan button 241 is designated, the process proceeds to step S43. If not, the process proceeds to step S45.

In step S43, document scanning portion 20 is controlled to scan an image of a document. Document scanning portion 20 outputs image data obtained by scanning a document. The image data output by document scanning portion 20 is thus obtained (step S44). The process then proceeds to step S49. In the next step S49, if the process proceeds from step S44, the image data obtained in step S44 is set as transmission data, and the process then returns to the data transmission process.

On the other hand, in step S45, it is determined whether Refer-to button 243 included in the data designation screen is designated. If Refer-to button 243 is designated, the process proceeds to step S46. If not, the process returns to step S42.

In step S46, a file list in which the file names of data stored in HDD 116 are listed is displayed on display portion 103, and the process then proceeds to step S47. In step S47, it is determined whether a file is selected. The process waits until a file name listed in the file list is selected (NO in step S47). If a file name is selected (YES in step S47), the process proceeds to step S48.

In step S48, data specified by the file name selected in step S47 is read out, and the process proceeds to step S49. In step S49, if the process proceeds from step S48, the data read out in step S48 is set as transmission data, and the process returns to the data transmission process.

As described above, MFP 100 in the first embodiment functions as an information processing apparatus to transmit image data obtained by scanning a document or data designated by the user among data stored in HDD 116, based on a plurality of destination information extracted from a plurality of displayed Web pages, so that the user can determine a plurality of destinations through the operation of displaying a plurality of Web pages.

Data is transmitted based on the destination information included in a Web page displayed in a window set in a viewable state when an instruction to transmit by the user is accepted. Therefore, if a window once opened is closed, data is not transmitted to the destination included in the Web page displayed in the closed window. Accordingly, a destination of data can be selected through the operation of setting a window in a viewable state. Furthermore, the user can confirm the destination on the Web page displayed in the window set in a viewable state.

The user can select a destination by performing the operation of opening or closing a window including a Web page before inputting an instruction to transmit.

### Second Embodiment

In the first embodiment, CPU 111 executes a plurality of browsing programs. In a second embodiment, it is assumed that a CPU 111A executes a single browsing program and the user performs browsing of a plurality of Web pages one by one. In the following, a difference from MFP 100 in the first embodiment will mainly be described.

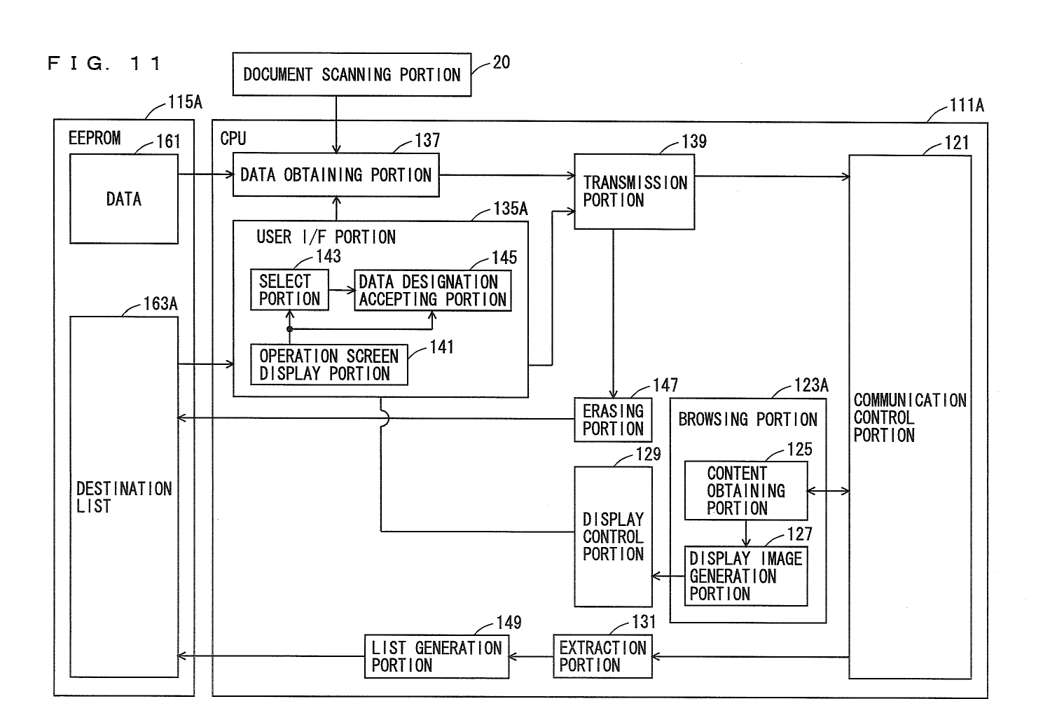

FIG. 11 is a block diagram showing an overall function of CPU of MFP 100 in the second embodiment together with information stored in EEPROM. Referring to FIG. 11, it differs from the block diagram shown in FIG. 5 in that first to N-th browsing portions 123-1 to 123-N and association portion 133 are deleted, user I/F portion 135 is changed to a user I/F portion 135A, and a browsing portion 123A, a list generation portion 149, and an erasing portion 147 are added. The same functions as the functions shown in FIG. 5 are denoted with the same reference numerals, and a description thereof will not be repeated here.

An EEPROM 115A stores data 161 and a destination list 163A. Destination list 163A will be described later.

Browsing portion 123A is a task formed in CPU 111A by CPU 111A executing a browsing program. Browsing portion 123A includes content obtaining portion 125 and display image generation portion 127. Content obtaining portion 125 and display image generation portion 127 have been described above and therefore a description thereof will not be repeated here.

CPU 111A forms one browsing portion 123A. Thus, when the user desires display of a plurality of Web pages, the user has to input a plurality of URLs one by one to display images of URLs in order. Display control portion 129 receives one display image at a time from display image generation portion 127, and every time a display image is input from display image generation portion 127, display control portion 129 overwrites the display image that has been displayed so far with the newly input display image.

Extraction portion 131 extracts a Web page from the data transmitted and received by communication control portion 121 through network I/F 118. Extraction portion 131 analyzes the extracted Web page to extract the destination information and the content identification information. When communication control portion 121 receives a plurality of Web pages, a plurality of destination information and content identification information are extracted. Extraction portion 131 outputs a set of the extracted destination information and content identification information to list generation portion 149.

List generation portion 149 generates a destination list. The destination list includes a destination record. The destination record includes an item of content identification information and an item of destination information. When a set of content identification information and destination information is input from extraction portion 131, list generation portion 149 generates a destination record in which the input content identification information is set in in the item of content identification information and the destination information is set in the item of destination information. List generation portion 149 adds the generated destination record to a destination list 163A stored in EEPROM 115.

Every time a set of content identification information and destination information is input from extraction portion 131, list generation portion 149 generates a destination record and adds the generated destination record to destination list 163A. Therefore, destination list 163A includes the same number of destination records as the number of times a display image of a Web page including destination information is displayed.

User I/F portion 135A includes an operation screen display portion 141, a select portion 143, and a data designation accepting portion 145. In response to the user inputting an instruction to display an operation screen to operation portion 105, operation screen display portion 141 reads out a destination record from destination list 163A and displays an operation screen including content identification information included in the read destination record on display portion 103. If a plurality of destination records are included in destination list 163A, an operation screen is displayed which includes a plurality of content identification information included in a plurality of destination records.

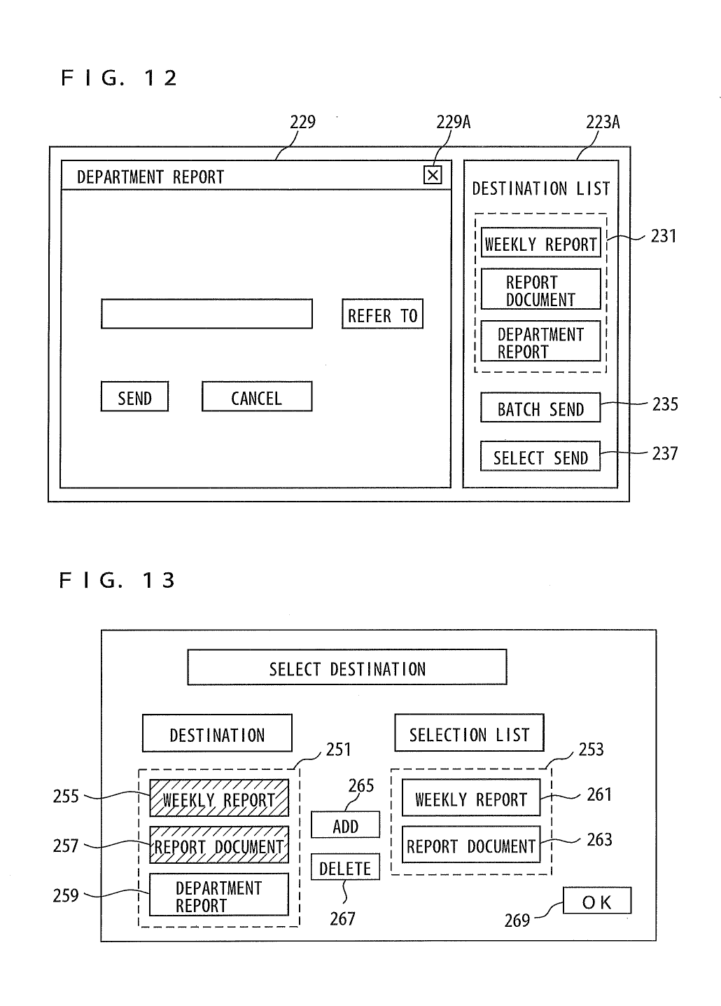

FIG. 12 shows an example of a display screen including the operation screen in the second embodiment. Referring to FIG. 12, the display screen includes a window including a Web page 229 and a window including an operation screen 223A. Operation screen 223A includes a destination list display region 231, a Batch Send button 235 labeled with a character string “BATCH SEND,” and a Select Send button 237 labeled with a character string “SELECT SEND.” An operation to designate batch transmission by the user is allocated to Batch Send button 235, and an operation to designate selective transmission by the user is allocated to Select Send button 237. It is noted that the dotted line in the figure is given only for the sake of illustration and actually does not exist.

Returning to FIG. 11, when the user designates Batch Send button 235 included in operation screen 223A, operation screen display portion 141 outputs to transmission portion 139 a plurality of destination information included in a plurality of destination records included in destination list 163A. When the user designates Send button 233 displayed on the operation screen, user I/F portion 135 outputs a data designation screen to display control portion 129. When a data designation screen is input from user I/F portion 135, display control portion 129 displays the data designation screen shown in FIG. 7 on display portion 103.

When the user designates Select Send button 237 included in operation screen 223A, operation screen display portion 141 outputs a select send instruction to select portion 143. When the select send instruction is input from operation screen display portion 141, select portion 143 generates a select screen, in which a plurality of content identification information included in a plurality of destination records included in destination list 163A stored in EEPROM 115A are displayed in a selectable manner, and outputs the generated select screen to display control portion 129. When the select screen is input from select portion 143, display control portion 129 displays the select screen on display portion 103.

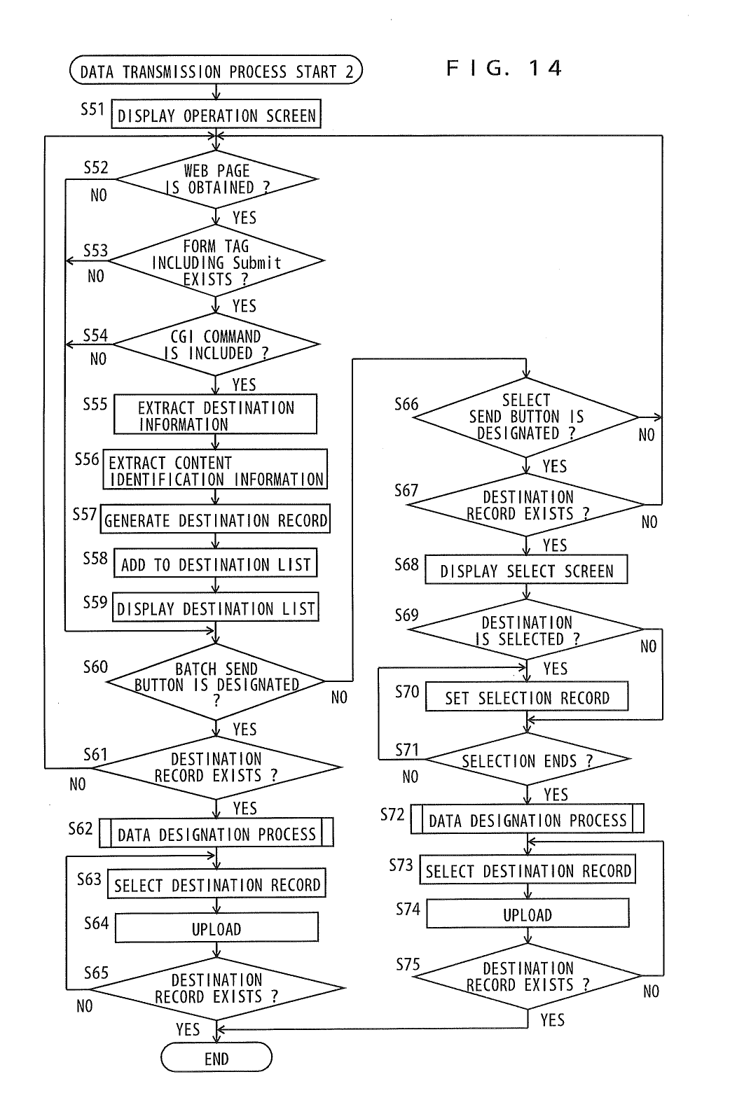

FIG. 13 shows an example of the select screen. Referring to FIG. 13, the select screen includes a possible destination display region 251, a selection list display region 253, an Add button 265 and a Delete button 267 arranged between possible destination display region 251 and selection list display region 253, and an OK button 269 arranged to the right of selection list display region 253. The select screen shown in FIG. 13 is displayed when the user designates Select Send button 237 included in the operation screen shown in FIG. 12. It is noted that the dotted line in the figure is given for the sake of illustration and actually does not exist.

Possible destination display region 251 is a region in which a plurality of content identification information included in a plurality of destination records included in destination list 163A are displayed in a selectable manner. Here, included are a button 255 labeled with a character string “weekly report,” a button 257 labeled with a character string “report document,” and a button 259 labeled with a character string “department report.” Buttons 255, 257, 259 displayed in possible destination display region 251 are displayed such that they can be selected and, when selected by the user, are highlighted. Here, it is shown by hatching that button 255 and button 257 are designated by the user and are highlighted.

Selection list display region 253 is a region in which content identification information selected by the user from among the content identification information displayed in possible destination display region 251 is displayed. If the user designates Add button 265 in a state in which at least one of a plurality of content identification information displayed in possible destination display region 251 is selected by the user, those selected by the user from among a plurality of content identification information displayed in possible destination display region 251 are displayed in selection list display region 253. Here, selection list display region 253 includes a button 261 labeled with a character string “weekly report” and a button 263 labeled with a character string “report document” to indicate that the content identification information “weekly report” and “report document” are selected as destinations.

Those selected by the user from among a plurality of content identification information displayed in selection list display region 253 are highlighted. If the user designates Delete button 267 in a state in which at least one of a plurality of content identification information displayed in selection list display region 253 is designated by the user, the one designated by the user from among a plurality of content identification information displayed in selection list display region 253 is deleted from selection list display region 253. If the user designates OK button 269, the content identification information displayed in selection list display region 253 is selected.

Returning to FIG. 11, select portion 143 sets, as a selection record, a destination record in which the content identification information selected by the user from among the content identification information displayed in the select screen is set in the item of content identification information. If the user selects a plurality of content identification information, select portion 143 extracts a plurality of destination records including a plurality of selected content identification information from destination list 163A stored in EEPROM 115A and sets a plurality of extracted destination records as selection records. Select portion 143 outputs a plurality of destination information included in a plurality of selection records to transmission portion 139. When OK button 269 included in the select screen is designated, select portion 143 outputs a data designation screen to display control portion 129. When a data designation screen is input from user I/F portion 135A, display control portion 129 displays the data designation screen shown in FIG. 7 on display portion 103.

Data designation accepting portion 145 accepts an operation of designating Scan button 241 or Refer-to button 243 displayed in the data designation screen. If the operation of the user designating Scan button 241 displayed in the data designation screen is accepted, data designation accepting portion 145 outputs a scan instruction to data obtaining portion 137. When the operation of the user designating Refer-to button 243 displayed in the data designation screen is accepted, data designation accepting portion 145 outputs a refer-to instruction to data obtaining portion 137.

Transmission portion 139 receives a plurality of destination information from operation screen display portion 141 or select portion 143 and receives transmission data from data obtaining portion 137. Transmission portion 139 transmits the transmission data input from data obtaining portion 137 based on each of a plurality of destination information input from operation screen display portion 141 or select portion 143. Therefore, the transmission data is transmitted based on the destination information set in each of all of a plurality of destination records included in destination list 163A stored in EEPROM 115A or a plurality of destination records selected therefrom. In other words, the transmission data is transmitted based on a plurality of destination information included in all of a plurality of Web pages browsed by the user and including destination information as a command for uploading or a plurality of Web pages selected therefrom by the user. When the transmission ends, transmission portion 139 outputs a transmission end signal to erasing portion 147 to indicate that the transmission has ended.

In response to the end of transmission of transmission data, erasing portion 147 deletes the destination list. Specifically, when the transmission end signal is input from transmission portion 139, erasing portion 147 erases all the destination records included in destination list 163A stored in EEPROM 115A. The destination list is thus erased in response to transmission of data. Therefore, if there exists next data to be transmitted, the user may display Web pages as upload destinations in order. Therefore, the operation of transmitting different data to different destinations becomes easy.

Although in the second embodiment CPU 111A forms one task executing a browsing program, by way of example, the present invention is applicable to the case where CPU 111A forms a plurality of tasks executing the browsing programs as in the first embodiment.

FIG. 14 is a flowchart showing an exemplary flow of a data transmission process in the second embodiment. Referring to FIG. 14, in step S51, operation screen 223A shown in FIG. 12 is displayed on display portion 103. In the next step S52, it is determined whether a Web page is obtained. If a Web page is obtained, the process proceeds to step S53. If not, the process proceeds to step S60. The process from step S53 to step S57 is the same as the process from step S17 to step S21, respectively, shown in FIG. 9, and therefore a description thereof will not be repeated here.

In step S58, the destination record generated in step S57 is added to destination list 163A stored in EEPROM 115A. In the next step S59, a list of destinations is displayed, and the process then proceeds to step S61. Specifically, operation screen 223A shown in FIG. 12 is displayed on display portion 103. Operation screen 223A includes destination list display region 231. Destination list display region 231 includes a plurality of content identification information set in a plurality of destination records included in destination list 163A stored in EEPROM 115A.

In step S60, it is determined whether the Batch Send button is designated. If the Batch Send button is designated, the process proceeds to step S61. If not, the process proceeds to step S66. In step S61, it is determined whether a destination record exists in destination list 163A stored in EEPROM 115A. If a destination record exists, the process proceeds to step S62. If not, the process returns to step S52. This is because if no destination record exists in destination list 163A, a Web page including destination information has never been displayed. The process from step S62 to step S65 is the same as the process from step S28 to step S31, respectively, shown in FIG. 9, and therefore a description thereof will not be repeated here.

On the other hand, in step S66, it is determined whether Select Send button 237 displayed in the operation screen is designated. If the Select Send button is designated, the process proceeds to step S67. If not, the process returns to step S52. The process in step S67 is similar to the process in step S61, and it is determined whether a destination record exists in destination list 163A. If a destination record exists, the process proceeds to step S68. If not, the process returns to step S52.

In step S68, the select screen shown in FIG. 13 is displayed on display portion 103. In the next step S69, it is determined whether a selection of destination is accepted. If a selection of destination is accepted, the process proceeds to step S70. If not, the process skips step S70 and proceeds to step S71. Specifically, if the user designates OK button 269 in a state in which content identification information is displayed in selection list display region 253 in the select screen, the selection of content identification information displayed in selection list display region 253 is accepted.

In step S70, a selection record is set. Specifically, the destination record including the content identification information selected in step S70 is set as a selection record. In step S71, it is determined whether an instruction to end selection of destination is accepted. If an instruction to end selection of destination is accepted, the process proceeds to step S72. If not, the process returns to step S70. In step S72, the data designation process shown in FIG. 10 is executed, and the process then proceeds to step S73.

In step S73, the destination record set as a selection record in step S70 is selected as a process target, and the process then proceeds to step S74. In step S74, the transmission data obtained in step S72 is uploaded based on the destination information included in the destination record selected as a process target, and the process then proceeds to step S75.

In step S76, it is determined whether there exists a selection record that has not yet been set as a process target. If there exists a selection record that has not yet been set as a process target, the data transmission process ends. If not, the process returns to step S73. Therefore, data is transmitted based on all the destination information set in destination records set as selection records at the moment when OK button 269 in the select screen is designated. In other words, data is transmitted based on the destination information that is included in the Web page displayed by the user and having content identification information selected by the user. Therefore, the user can select a destination of transmission data before designating OK button 269 in the select screen.

In MFP 100 in the second embodiment, every time a Web page is displayed, destination information is added to destination list 163A, so that the user can add a destination to which data is transmitted, through the operation of displaying a plurality of Web pages in order.

Furthermore, data is transmitted to the destination selected from among a plurality of destination information included in destination list 163A, so that the user can transmit data selectively from a plurality of destinations.

Destination list 163A is erased from EEPROM 115A after data is transmitted, so that different data can be transmitted to different destinations.

Although MFP 100 has been described as an example of the information processing apparatus in the foregoing embodiments, the present invention can be understood as a data transmission method for causing MFP 100 to execute the data transmission process shown in FIG. 9 or FIG. 14 as well as a data transmission program for causing a computer to execute the data transmission method, as a matter of course.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus comprising:
a content obtaining portion to obtain content written in a markup language;
an extraction portion to extract destination information by analyzing said obtained content;
a content display portion to display said obtained content;
a generation portion to generate a set of destination information by successively adding a plurality of destination information extracted from a plurality of contents displayed by said content display portion; and
a transmission portion to transmit data based on said generated set of destination information.

2. The information processing apparatus according to claim 1, wherein
said content display portion can set a plurality of windows including contents in a viewable state,
the information processing apparatus further comprises an association portion to associate destination information extracted by said extraction portion with a window set in a viewable state by said content display portion, and
said transmission portion transmits said data based on the destination information associated by the association portion.

3. The information processing apparatus according to claim 2, further comprising a deletion portion to, if one of said plurality of windows is closed, delete the destination information associated with said closed window from said generated set of destination information.

4. The information processing apparatus according to claim 2, wherein said transmission portion transmits said data based on the destination information extracted from the content included in the window displayed when an instruction to transmit by the user is accepted.

5. The information processing apparatus according to claim 1, further comprising a list generation portion to add destination information to a list every time content is displayed by said content display portion, wherein
said transmission portion transmits said data based on destination information included in the list generated by said list generation portion.

6. The information processing apparatus according to claim 5, further comprising a select portion to select destination information from a plurality of destination information included in the list generated by the list generation portion, wherein
said transmission portion transmits said data based on said selected destination information.

7. The information processing apparatus according to claim 5, further comprising a list erasing portion to erase the list generated by said list generation portion after said data is transmitted by said transmission portion.

8. The information processing apparatus according to claim 1, further comprising an image scanning portion to output image data obtained by scanning a document, wherein
said transmission portion transmits image data output by said image scanning portion.

9. The information processing apparatus according to claim 1, further comprising a storage portion to store data, wherein
said transmission portion transmits data stored in said storage portion.

10. A data transmission method executed in an information processing apparatus comprising the steps of:
obtaining content written in a markup language;
extracting destination information by analyzing said obtained content;
displaying said obtained content;
generating a set of destination information by successively adding a plurality of destination information extracted from a plurality of contents displayed in said step of displaying content; and
transmitting data based on said generated set of destination information.

11. The data transmission method according to claim 10, further comprising the step of associating destination information extracted in said step of extracting with a window in which content is set in a viewable state in said step of displaying content, wherein
said step of transmitting includes the step of transmitting said data based on the destination information associated in said step of associating.

12. The data transmission method according to claim 11, further comprising the step of, if one of a plurality of windows in which said plurality of contents are set in a viewable state is closed, deleting the destination information associated with said closed window from said generated set of destination information.

13. The data transmission method according to claim 11, wherein said step of transmitting includes the step of transmitting said data based on the destination information extracted from the content included in the window displayed when an instruction to transmit by the user is accepted.

14. The data transmission method according to claim 10, further comprising the step of adding destination information to a list every time content is displayed in said step of displaying content, wherein
said step of transmitting includes the step of transmitting said data based on destination information included in the list generated in said step of adding to a list.

15. The data transmission method according to claim 14, further comprising the step of selecting destination information from a plurality of destination information included in the list generated in said step of adding to a list, wherein
said step of transmitting includes the step of transmitting said data based on said selected destination information.

16. The data transmission method according to claim 14, further comprising the step of erasing the list generated in said step of adding to a list after said data is transmitted in said step of transmitting.

17. A computer-readable non-transitory recording medium encoded with a data transmission program causing a computer to execute processing comprising the steps of:
obtaining content written in a markup language;
extracting destination information by analyzing said obtained content;
displaying said obtained content;
generating a set of destination information by successively adding a plurality of destination information extracted from a plurality of contents displayed in said step of displaying content; and
transmitting data based on said generated set of destination information.

18. The computer-readable non-transitory recording medium encoded with a data transmission program according to claim 17, further causing the computer to execute the step of associating destination information extracted in said step of extracting with a window in which content is set in a viewable state in said step of displaying content, wherein
said step of transmitting includes the step of transmitting said data based on the destination information associated in said step of associating.

19. The computer-readable non-transitory recording medium encoded with a data transmission program according to claim 18, further causing the computer to execute the step of, if one of a plurality of windows in which said plurality of contents are set in a viewable state is closed, deleting the destination information associated with said closed window from said generated set of destination information.

20. The computer-readable non-transitory recording medium encoded with a data transmission program according to claim 18, wherein said step of transmitting includes the step of transmitting said data based on the destination information extracted from the content included in the window displayed when an instruction to transmit by the user is accepted.

21. The computer-readable non-transitory recording medium encoded with a data transmission program according to claim 17, further causing the computer to execute the step of adding destination information to a list every time content is displayed in said step of displaying content, wherein
said step of transmitting includes the step of transmitting said data based on destination information included in the list generated in said step of adding to a list.

22. The computer-readable non-transitory recording medium encoded with a data transmission program according to claim 21, further causing the computer to execute the step of selecting destination information from a plurality of destination information included in the list generated in said step of adding to a list, wherein
said step of transmitting includes the step of transmitting data said based on said selected destination information.

23. The computer-readable non-transitory recording medium encoded with a data transmission program according to claim 22, further causing the computer to execute the step of erasing the list generated in said step of adding to a list after said data is transmitted in said step of transmitting.
